(19) United States
(12) Patent Application Publication
(10) Pub. No.: US 2006/0130978 A1
(43) Pub. Date: Jun. 22, 2006

(54) Aid tool for protective adhesive tape

(76) Inventors: Ming-Kun Li, Taichung (TW); Li-Chu Lai, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/015,250

(22) Filed: Dec. 20, 2004

(51) Int. Cl. B29C 63/00; B32B 37/00

(52) U.S. Cl. 156/584; 156/580

(57) ABSTRACT

An aid tool for a protective adhesive tape includes a flat plate, a fixing member mounted on a surface of the flat plate, and a scraper mounted on a side of the flat plate. Thus, the scraper is driven by the flat plate to roll and press the protective adhesive tape, thereby preventing from producing air bubbles between the protective adhesive tape and the surface of the object, so that the protective adhesive tape is bonded on the surface of the object closely and tightly.

### BACKGROUND OF THE INVENTION

1. Field of the Invention

The present invention relates to an aid tool, and more particularly to an aid tool for a protective adhesive tape.

2. Description of the Related Art

A conventional protective adhesive tape has a film detachably mounted thereon. When in use, the film is removed from the protective adhesive tape, so that the protective adhesive tape is bonded on the surface of an object. Usually, the protective adhesive tape is bonded on the surface of the object by aid of a tool, such as a ruler, plate or the like. However, air bubbles easily produce between the protective adhesive tape and the surface of the object during the bonding process, so that the protective adhesive tape is not bonded on the surface of the object closely and tightly. In addition, the protective adhesive tape is easily worn out by the aid tool during operation, thereby decreasing the lifetime of the protective adhesive tape.

### SUMMARY OF THE INVENTION

In accordance with the present invention, there is provided an aid tool, comprising a flat plate; and a fixing member mounted on a surface of the flat plate.

The primary objective of the present invention is to provide an aid tool that facilitates bonding a protective adhesive tape on an object.

Another objective of the present invention is to provide an aid tool, wherein the scraper is driven by the flat plate to roll and press the protective adhesive tape, thereby preventing from producing air bubbles between the protective adhesive tape and the surface of the object, so that the protective adhesive tape is bonded on the surface of the object closely and tightly.

A further objective of the present invention is to provide an aid tool, wherein the scraper is driven by the flat plate to roll and press the protective adhesive tape, so that the protective adhesive tape is bonded on the surface of the object smoothly, thereby preventing the protective adhesive tape from being worn out during operation so as to enhance the lifetime of the protective adhesive tape.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an aid tool in accordance with the preferred embodiment of the present invention;

FIG. 2 is a schematic operational view of the aid tool as shown in FIG. 1 in use;

FIG. 3 is a locally enlarged cross-sectional view of the aid tool as shown in FIG. 2;

FIG. 4 is a perspective view of an aid tool in accordance with another embodiment of the present invention; and

FIG. 5 is a perspective view of an aid tool in accordance with another embodiment of the present invention.

### DETAILED DESCRIPTION OF THE INVENTION

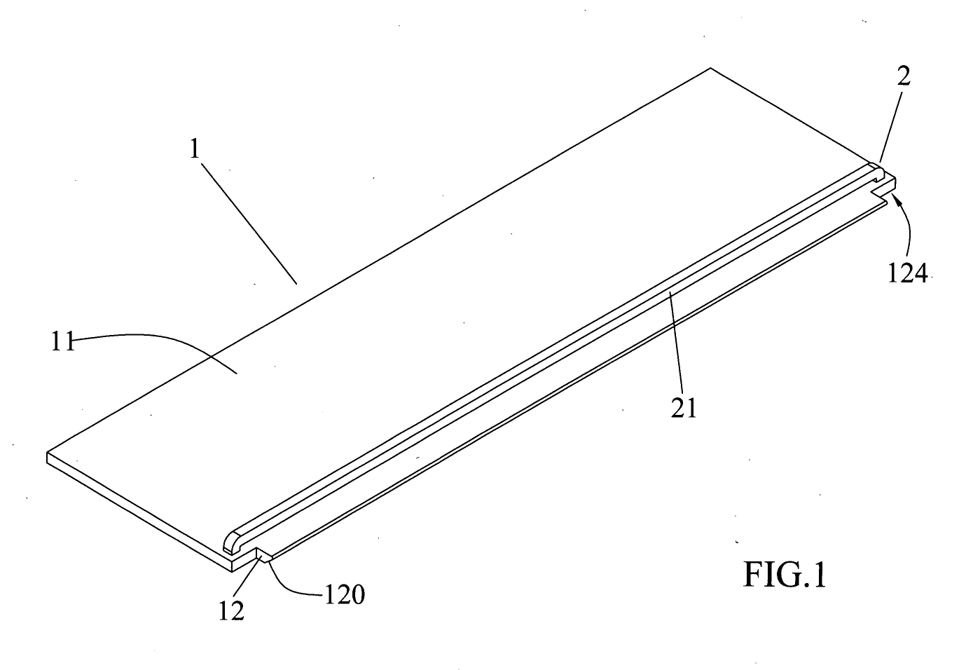

Referring to the drawings and initially to FIGS. 1-3, an aid tool for a protective adhesive tape in accordance with the preferred embodiment of the present invention comprises a flat plate 1, and a fixing member 2 mounted on a surface 11 of the flat plate 1.

The flat plate 1 is an elongated plate made of a rigid material.

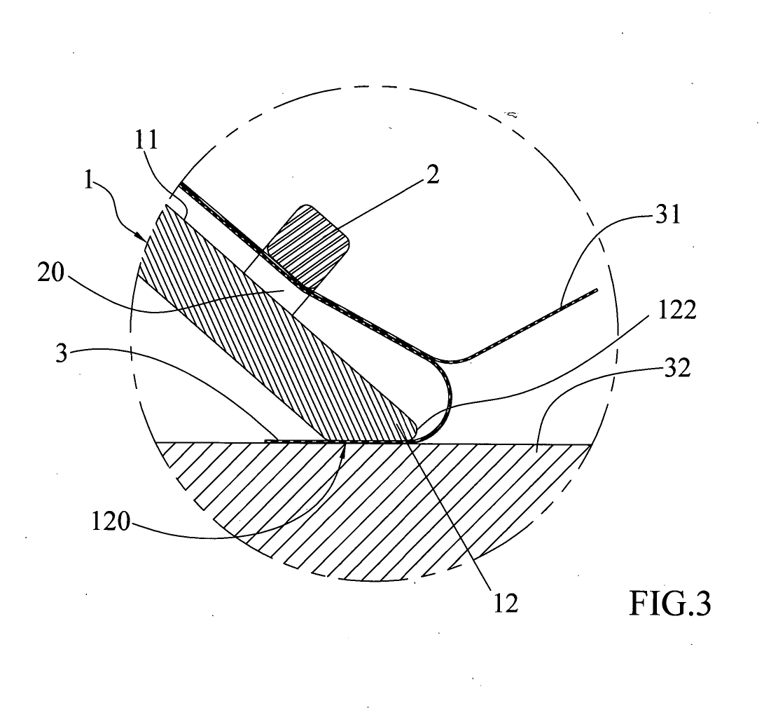

The fixing member 2 includes an elongated strip 21 made of a rigid material secured on the surface 11 of the flat plate 1, with a gap 20 (see FIG. 3) defined between the surface 11 of the flat plate 1 and the elongated strip 21 of the fixing member 2. Preferably, the elongated strip 21 of the fixing member 2 has a rectangular shape.

The aid tool further comprises a scraper 12 mounted on a side of the flat plate 1. Preferably, the scraper 12 is integrally formed on the flat plate 1 and located adjacent to the fixing member 2. Preferably, the scraper 12 has an inclined side face 120 and has an arc-shaped edge 122 (see FIG. 3) connected to the surface 11 of the flat plate 1. In addition, the scraper 12 has two opposite ends each formed with a cutout 124.

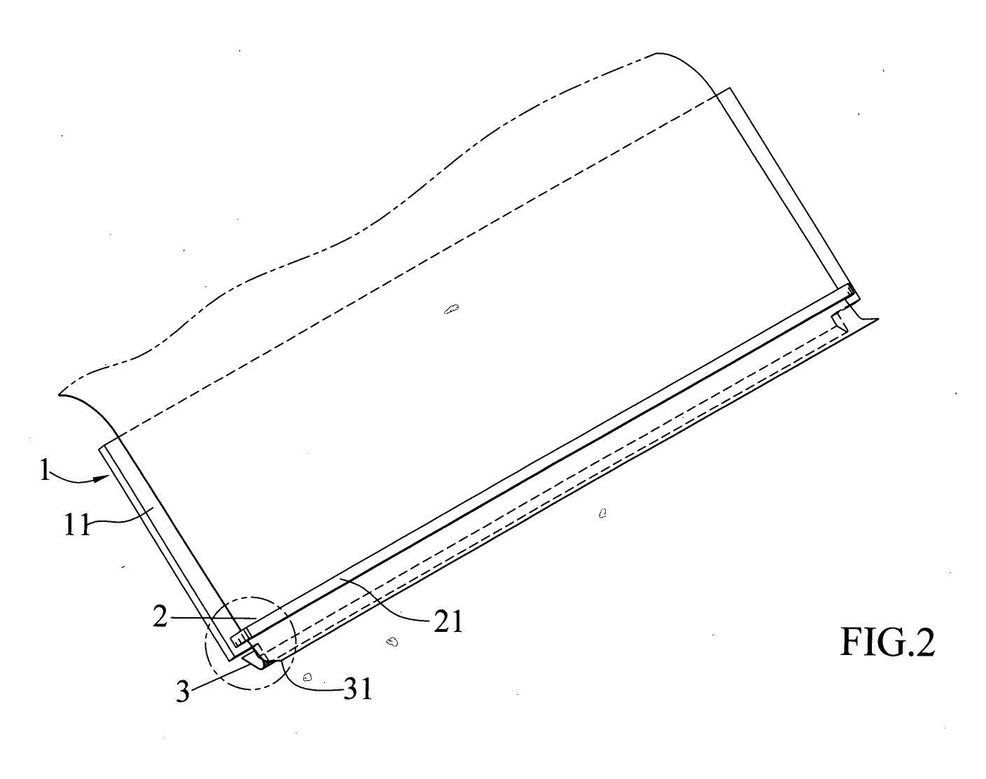

When in use, as shown in FIGS. 2 and 3, a protective adhesive tape 3 is initially extended through the gap 20 between the surface 11 of the flat plate 1 and the elongated strip 21 of the fixing member 2. At this time, the elongated strip 21 of the fixing member 2 provides a support to the protective adhesive tape 3. Then, the film 31 of the protective adhesive tape 3 is removed from the protective adhesive tape 3. Then, the stripped end of the protective adhesive tape 3 passes the scraper 12 and is rested on the surface of an object 32, so that the stripped end of the protective adhesive tape 3 is clamped between the scraper 12 and the surface of the object 32. Then, the flat plate 1 is pushed to move on the surface of the object 32 to drive the scraper 12 to roll and press the protective adhesive tape 3, so that the protective adhesive tape 3 is separated from the film 31 and is bonded on the surface of the object 32 closely.

In such a manner, the scraper 12 is driven by the flat plate 1 to roll and press the protective adhesive tape 3, thereby preventing from producing air bubbles between the protective adhesive tape 3 and the surface of the object 32, so that the protective adhesive tape 3 is bonded on the surface of the object 32 closely and tightly. In addition, the scraper 12 is driven by the flat plate 1 to roll and press the protective adhesive tape 3, so that the protective adhesive tape 3 is bonded on the surface of the object 32 smoothly, thereby preventing the protective adhesive tape 3 from being worn out during operation so as to enhance the lifetime of the protective adhesive tape 3.

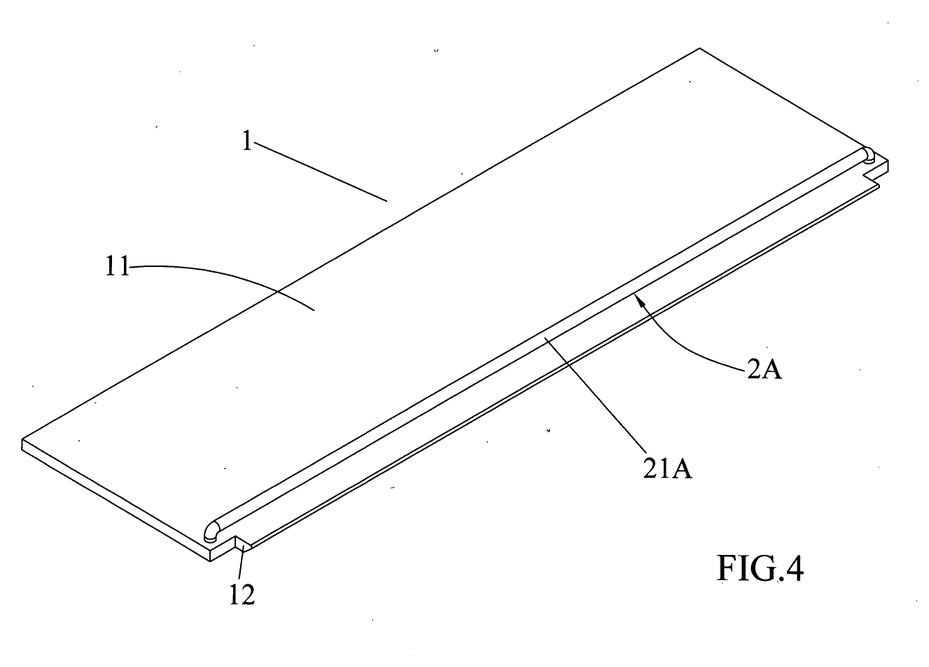

Referring to FIG. 4, the fixing member 2A includes an elongated rod 21A made of a rigid material secured on the surface 11 of the flat plate 1.

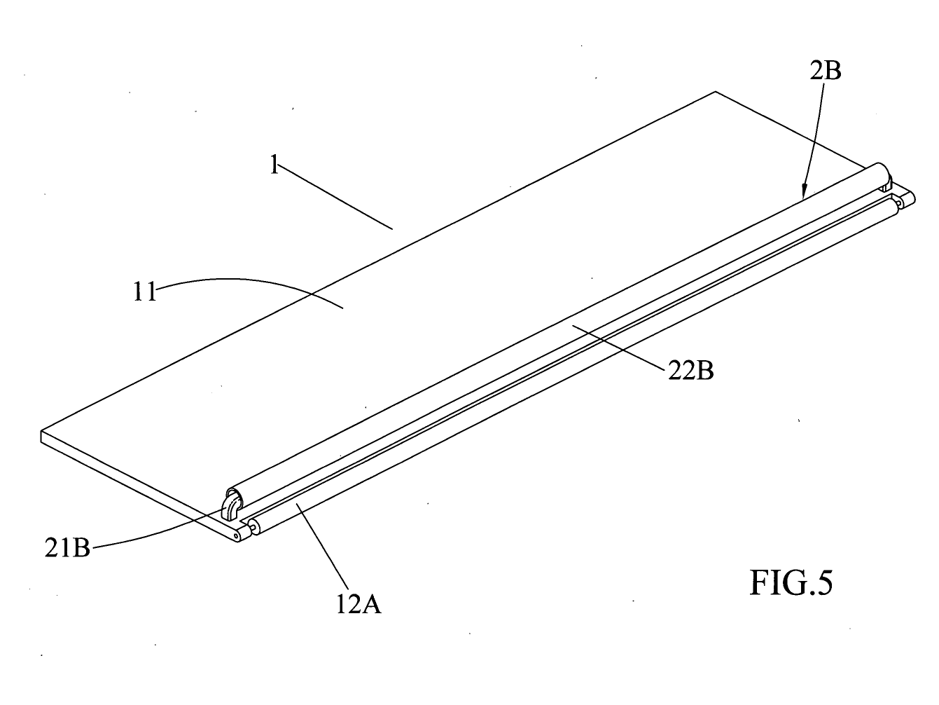

Referring to FIG. 5, the fixing member 2B includes an elongated strip 21B secured on the surface 11 of the flat plate 1, and a mounting tube 22B mounted on the elongated strip 21B. In addition, the aid tool further comprises a rolling cylinder 12 rotatably mounted on a side of the flat plate 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An aid tool, comprising:
a flat plate having a flat surface;
a fixing member mounted on the flat surface of the flat plate;
wherein the fixing member includes an elongated strip secured on the flat surface of the flat plate;
wherein the elongated strip of the fixing member is substantially inverted U-shaped and has two protruding distal ends secured to the flat surface of the flat plate to space the elongated strip of the fixing member from the flat surface of the flat plate, with a gap defined between the flat surface of the flat plate and the elongated strip of the fixing member.

2. The aid tool in accordance with claim 1, wherein the flat plate is an elongated plate made of a rigid material.

3. (canceled)

4. The aid tool in accordance with claim 1, wherein the elongated strip of the fixing member is made of a rigid material.

5. The aid tool in accordance with claim 1, wherein the elongated strip of the fixing member has a rectangular shape.

6. The aid tool in accordance with claim 1, further comprising a scraper mounted on a side of the flat plate.

7. The aid tool in accordance with claim 6, wherein the scraper is integrally formed on the flat plate.

8. The aid tool in accordance with claim 6, wherein the scraper is located adjacent to the fixing member.

9. The aid tool in accordance with claim 6, wherein the scraper has an inclined side face having a flat shape.

10. The aid tool in accordance with claim 9, wherein the scraper has an arc-shaped edge connected between the inclined side face and the flat surface of the flat plate.

11. The aid tool in accordance with claim 6, wherein the scraper has two opposite ends each formed with a cutout.

12. (canceled)

13. The aid tool in accordance with claim 1, wherein the fixing member further includes a mounting tube mounted on the elongated strip to facilitate passage of a protective adhesive tape which is extended through the gap defined between the flat surface of the flat plate and the elongated strip of the fixing member.

14. The aid tool in accordance with claim 13, further comprising a rolling cylinder rotatably mounted on a side of the flat plate to press the protective adhesive tape smoothly.

15. The aid tool in accordance with claim 1, wherein the flat surface of the flat plate extends through a whole length and a whole width of the flat plate.
